(19) United States
(12) Patent Application Publication
(10) Pub. No.: US 2008/0203078 A1
(43) Pub. Date: Aug. 28, 2008

(54) WINDSHIELD HEATER

(76) Inventor: MICHAEL CARL HUERTER, Wamego, KS (US)

Correspondence Address: MCKEE, VOORHEES & SEASE, P.L.C., 801 GRAND AVENUE, SUITE 3200, DES MOINES, IA, 50309-2721, US

(21) Appl. No.: 11/678,357

(22) Filed: Feb. 23, 2007

(51) Int. Cl. B60J 1/00; B60L 1/02

(52) U.S. Cl. 219/203; 432/13

(57) ABSTRACT

The present invention is a vehicle windshield assembly for assisting a vehicle defroster in melting ice or snow on a vehicle windshield by engaging and heating an outer circumference area of an inner side of the windshield using a flexible electrical heating element, an adhesive for adhering the heating element to the windshield, an electrical conductor for electrically connecting the heating element to an electrical outlet in the vehicle, and an electrical control device for controlling operation of the heating element at a plurality of heating levels. The heating element may be capable of plugging directly into a universal vehicle power outlet, lighter socket, fuse box, or the vehicle's electrical system. A heating element is held to an outer perimeter of the windshield using a flexible adhesive tape, a permanent adhesive, or may be sandwiched between two panels of glass forming the windshield.

### BACKGROUND OF THE INVENTION

The present invention relates to windshield heater. Specifically, the present invention relates to a heating device for assisting a vehicle defrost system in the removal of snow and ice from vehicle windshields.

In fair weather, traditional defroster systems in vehicles are adequate in removing snow and ice from the vehicle windshield. However, sometimes when it is snowing heavy or wet snow or freezing rain and the vehicle is driving down the highway, ice tends to start collecting on windshield wiper blades and around the outer perimeter of the windshield. As the driver continues driving, the ice starts building inward until the driver's view is partially or completely blocked. This creates a dangerous situation. In view of the foregoing problem, it is desirable to have an improvement in the art to assist vehicle defrost systems to remove or prevent ice from building up on the windshield during snow, sleet, or freezing rain.

As a result, the primary feature or advantage of the present invention is an improved windshield heater.

Another feature or advantage of the present invention is a windshield heater capable of being installed as an after market heater device.

Another feature or advantage of the present invention is a windshield heater capable of being manufactured onto the windshield as original equipment.

Another feature or advantage of the present invention is a windshield heater which does not require a hardwire connection to the vehicle's wiring harness system.

Another feature or advantage of the present invention is the provision of a windshield heater which can easily adjust the amount of heat provided to the windshield.

Another feature or advantage of the present invention is a provision of a windshield heater which is economical to manufacture, durable in use, and efficient in operation.

These and or other features or advantages of the present invention will become apparent to those ordinarily skilled in the art from the specification and claims that follow.

### BRIEF SUMMARY OF THE INVENTION

The afore-mentioned features and advantages may be accomplished by a vehicle windshield heater assembly for assisting a vehicle defroster in melting ice on a vehicle windshield by engaging and heating an outer circumference area of the interior surface of the windshield with a flexible electrical heating element, an adhesive for adhering the heating element to the windshield, an electrical conductor for electrically connecting the heating element to an electrical outlet in the vehicle, and an electrical control device for controlling operation of the heating element for multiple heating levels.

The foregoing features or advantages may additionally be accomplished by a heater assembly having a universal vehicle electrical plug for electrically mating the heating element with a universal vehicle lighter socket, a vehicle power outlet socket, or a vehicle fuse box.

The foregoing features or advantages may additionally be accomplished by a heater assembly having a control device incorporated into a universal vehicle electrical plug for controlling the heater assembly.

The foregoing features or advantages may be achieved by a heater assembly configured as an after market addition to a vehicle windshield.

The foregoing features or advantages may additionally be accomplished by a heater assembly using a clear, flexible adhesive tape for adhering the heater assembly to the windshield.

The foregoing features or advantages may additionally be accomplished by having a heater assembly capable of plugging directly into a vehicle fuse box to power the heating element.

The foregoing features or advantages may additionally be accomplished by an after market windshield de-icing device having a flexible electrical heating element, a flexible adhesive tape for adhering the heating element to an inner side of the windshield and approximately following an outer circumference of the windshield, an electrical conductor having a first end electrically connected to the heating element, a universal vehicle electrical plug electrically connected to a second end of the electrical conductor, and an electrical control device electrically connected to the heating element for controlling operation of the heating element.

In addition, the foregoing features or advantages may be accomplished by a heating element permanently adhered to the outer circumference area of a windshield and attached to the vehicle's electrical system.

### BRIEF DESCRIPTION OF THE DRAWINGS

FIG. 1 shows a vehicle having one embodiment of the windshield heater of the present invention installed around a perimeter of the windshield.

FIG. 2 shows a view of the windshield and dashboard area of the vehicle in FIG. 1.

FIG. 3 shows an enlarged view of the area 3-3 of FIG. 2.

FIG. 4 shows an enlarged view of the area 4-4 of FIG. 2.

FIG. 5 shows another embodiment of the windshield heater of the present invention.

FIG. 6 shows still another embodiment of the windshield heater of the present invention.

### DETAILED DESCRIPTION OF THE PREFERRED EMBODIMENT

The present invention relates to a vehicle windshield heater. Specifically, the present invention relates to a windshield heater which can be used as an OEM or after market addition to a windshield to help keep snow and ice from building up on a windshield while driving in snow, sleet, or freezing rain.

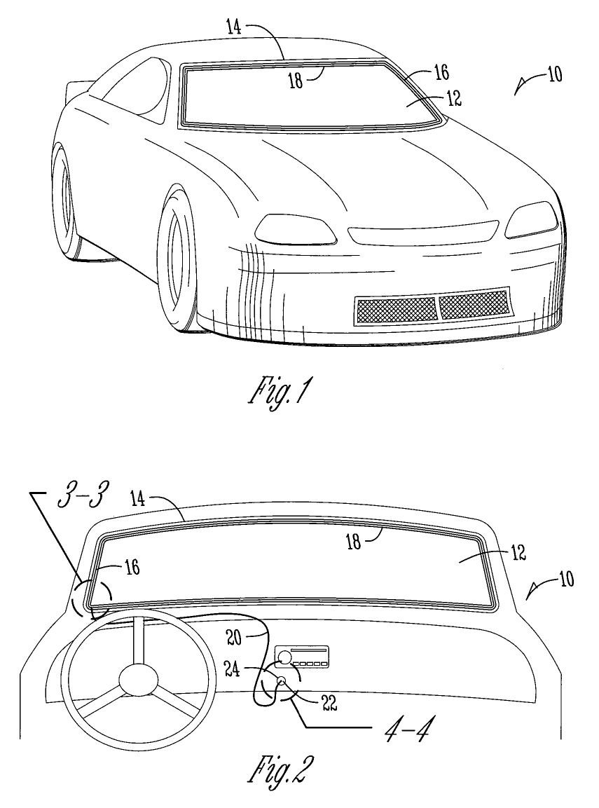

FIG. 1 shows one embodiment of the present invention installed on a standard vehicle 10. It is intended that the present invention be used on any type of vehicle which may be used when snow or ice are likely to develop on the windshield 12 of the vehicle 10.

FIGS. 1 and 2 show that the windshield 12 has a perimeter 14 around the outer edge of the windshield 12. The windshield perimeter 14 does not necessarily mean right at the edge of the windshield, but the general area around the outer portion of the windshield 12. However, the heating element 16 of the present invention should be located adjacent the outer perimeter 14 of the windshield 12 so as to not interfere with the driving view of the driver of the vehicle 10. This is to ensure a safe driving environment for the driver of the vehicle 10.

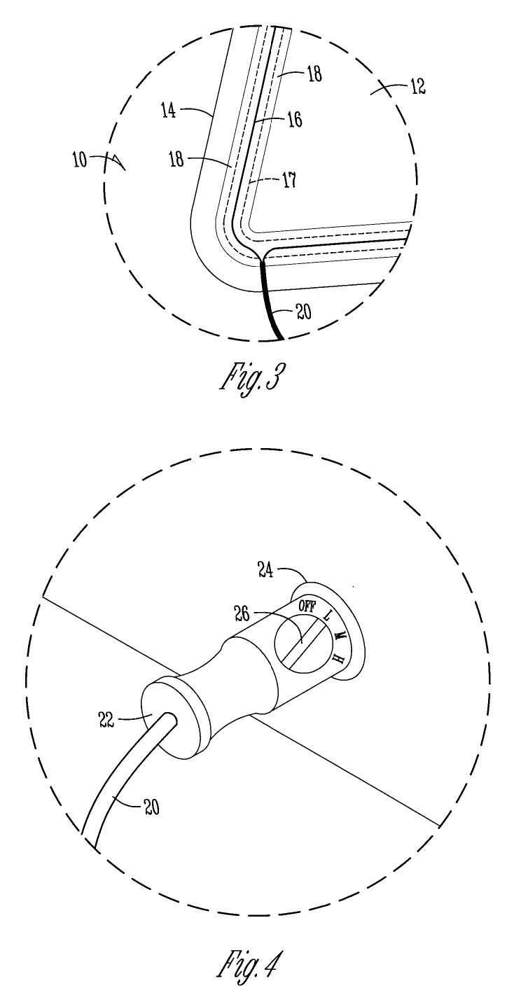

As shown best in FIGS. 1-3, a heating element 16 is preferred to be held or adhered to the inside surface of the windshield 12 using a flexible adhesive tape 18 laid over the heating element 16 and adhered adjacent the perimeter 14 of the windshield 12. A foil layer 17, or similar material, may be provided over the element 16 so as to reflect heat onto the windshield 12. Using a tape adhesive 18 to hold the heating element 16 to the windshield 12 allows for a good thermal conductivity between the heating element 16 and the windshield 12 to help transfer the heat created by the heating element 16 to the windshield 12, and thus melt ice and snow. The tape adhesive 18 may be removable from the glass of the windshield 12 so that the heating element 16 can be replaced, or transferred to a different vehicle. Preferably the tape 18 is clear to minimize blocking of the view to the vehicle's driver.

The heating element 16 is preferably a flexible resistance heating element that receives electricity to heat the heating element 16 and transfer the heat to the windshield 12 by directly contacting the windshield 12 and thus not relying on the vehicle's 10 built-in defrosting system. Thus, the windshield heater of the present invention operates separate from the vehicle's defrost system and can operate even if the onboard defrost system is inoperable.

FIGS. 2-4 show that the heating element 16 is attached via electrical wires or an electrical cable or conductor 20 using a universal vehicle electrical plug 22 to plug in the heating element 16 to a universal vehicle power outlet or cigarette lighter receptacle 24. Universal vehicle electrical plug 22 and receptacle 24 are well known to those skilled in the art.

As a result, the present invention can be easily added as an after market feature to boost defrost or ice melting capability of any vehicle 10 having a cigarette lighter receptacle or universal vehicle power receptacle 24. The electrical cable or conductor 20 should be sized to handle the current draw which may be seen by the heating element 16.

As shown in FIG. 4, the universal electrical plug 22 may have a control switch 26 built-in to the universal electrical plug. A control switch or device 26 can use any kind of an electrical control circuitry to create the desired operation of the heating element 16. For example, the control switch device 26 and supporting electronics may be configured to operate the heating element 16 in and off, low, medium, and high range. This feature allows the user to avoid putting a high electrical drain or stress on the vehicle's electrical generating system unless it is demanded by the weather situation forming the ice or snow on the vehicle's windshield 12.

When the heating element 16 is adhered to the windshield 12 and the universal electrical plug 22 is inserted into a universal vehicle power outlet or lighter receptacle 24 on the vehicle 10 and the control switch device 26 is placed in one of the on positions, electricity will flow through electrical cable or conductor 20 to the heating element 16, thereby generating heat in the heating element 16 which passes through the windshield 12 to melt the snow or ice on the outside surface of the windshield 12.

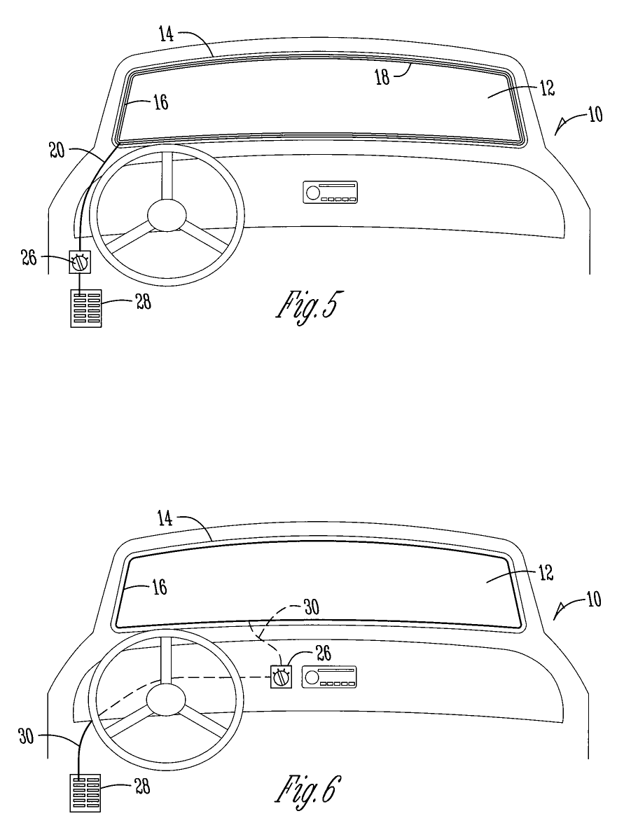

FIG. 5 shows another embodiment of the present invention where the electrical cable or conductor 20 passes through a control switch device 26 and plugs directly into the vehicle fuse box 28. Thus, instead of using a universal vehicle electrical plug 22, the device may be constructed using an adapter for plugging into the different configurations of fuse receptacles on vehicles. Therefore, if a vehicle is not equipped with a power outlet 24, the heating element 16 can still be used by plugging into the vehicle fuse box 28. The adapter 4 connecting the electrical cable or conductor 20 into the vehicle fuse box 28 is not shown, however one of ordinary skill in the art would easily appreciate the configuration of this device and will understand that the configuration of this adaptor will change depending upon the type of fuse used for the specific vehicle.

In addition, the present invention may be equipped by an electrical quick-connect adaptor for plugging directly into a vehicle wiring harness 30. Another embodiment of the present invention, shown in FIG. 6, is a heating element 16 that is glued or otherwise adhered to the perimeter 14 of the windshield 12. These embodiments easily lend themselves to be used for original equipment on the vehicle 10.

One advantage of the present invention is that it can be used to benefit those who drive a lot in snowy and icy weather. One use for the present invention is for snow removal trucks commonly driven by municipalities and counties during snowy weather. As the vehicle drives through the snowy weather the heating element 16 of the present invention can help keep the accumulation of snow and ice to a minimum on the windshield 12 of the vehicle 10 and thus increase safety.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A vehicle windshield heater assembly for assisting a vehicle defroster in melting ice on a vehicle windshield by engaging and heating an outer circumference area of an interior surface of the windshield, the assembly comprising:
a flexible electrical heating element;
an adhesive for adhering the heating element to the interior surface of the windshield;
an electrical conductor for electrically connecting the heating element to an electrical outlet in the vehicle; and
an electrical control device for controlling operation of the heating element at a plurality of heating levels.

2. The heater assembly of claim 1 further comprising a universal vehicle electrical plug for electrically mating the electrical conductor with a universal vehicle lighter socket or vehicle power outlet socket.

3. The heater assembly of claim 2 wherein the control device is incorporated into the universal vehicle electrical plug.

4. The heater assembly of claim 3 wherein the control device controls the heating element at low, medium, and high temperatures.

5. The heater assembly of claim 1 configured as an after market addition to a vehicle.

6. The heater assembly of claim 1 wherein the adhesive is a flexible tape adhesive.

7. The heater assembly of claim 6 wherein the tape adhesive is clear.

8. The heater assembly of claim 1 wherein the adhesive is a glue adhesive.

9. The heater assembly of claim 1 wherein the electrical conductor is configured to plug directly into a vehicle fuse box to power the heating element.

10. An aftermarket windshield de-icing device comprising:
a flexible electrical heating element;
a flexible adhesive tape for adhering the heating element to an interior surface of the windshield and approximately following an outer circumference of the windshield;
an electrical conductor having a first end electrically connected to the heating element;
a universal vehicle electrical plug electrically connected to a second end of the electrical conductor; and
an electrical control device electrically connected to the heating element for controlling operation of the heating element.

11. The device of claim 10 wherein the electrical control device is incorporated into the universal vehicle electrical plug.

12. The device of claim 11 wherein the electrical control device controls on/off and multiple heating levels for the heating element.

13. In combination with a vehicle windshield, a heater assembly for assisting a vehicle defroster in melting ice on a vehicle windshield by engaging and heating an outer circumference area of the windshield, the assembly comprising:
an electrical heating element adhered to the outer circumference area of the windshield;
an electrical conductor for electrically connecting the heating element to an electrical system in the vehicle; and
an electrical control device electrically connected to the heating element for controlling operation of the heating element at a plurality of heating levels.

14. The windshield heater assembly of claim 13 wherein the heating element is adhered to an interior surface of the windshield.

15. A method of de-icing a vehicle windshield, comprising:
adhering an electrical heating element to an interior surface of the windshield so as to extend in a loop around the windshield adjacent the perimeter of the windshield;
plugging an electrical conductor connected to the heating element into an electrical receptacle of the vehicle; and
providing power to the receptacle so as to supply an electrical current to the heating element so as to melt ice or the outer surface of the windshield.

16. The method of claim 15 further comprising actuating a control device on the conductor to adjust the current supplied to the heating element.
